(19) United States
(12) Patent Application Publication
(10) Pub. No.: US 2012/0213108 A1
(43) Pub. Date: Aug. 23, 2012

(54) RADIO RESOURCE MONITORING (RRM) AND RADIO LINK MONITORING (RLM) PROCEDURES FOR REMOTE RADIO HEAD (RRH) DEPLOYMENTS

(75) Inventors: Tingfang Ji, San Diego, CA (US); Peter Gaal, San Diego, CA (US); Hao Xu, San Diego, CA (US); Osok Song, San Diego, CA (US)

(73) Assignee: QUALCOMM INCORPORATED, San Diego, CA (US)

(21) Appl. No.: 13/401,557

(22) Filed: Feb. 21, 2012

Related U.S. Application Data
(60) Provisional application No. 61/445,411, filed on Feb. 22, 2011.

(51) Int. Cl. H04W 74/08; H04W 4/06; H04W 24/00

(52) U.S. Cl. 370/252; 370/241; 370/328

(57) ABSTRACT

Wireless networks may include remote radio heads (RRHs) for extending the coverage of a macro cell. The macro cell may be connected to the RRHs, for example, by optical fiber, and there may be negligible latency between the macro cell and the RRHs. RRH deployment with different cell specific RS transmissions may create many cell edges, which may present challenges in idle state mobility. Certain aspects of the present disclosure may utilize coordinated multipoint (CoMP) transmissions for idle user equipment (UE) support and, in some aspects, may introduce new radio link monitoring (RLM) techniques. As a result, the techniques presented herein may help achieve better idle mode performance and/or better RLM performance.

### CROSS-REFERENCE TO RELATED APPLICATION

This application claims priority to U.S. Provisional Application Ser. No. 61/445,411, filed on Feb. 22, 2011, entitled Radio Resource Monitoring (RRM) and Radio Link Monitoring (RLM) Procedures for Remote Radio Head (RRH) Deployment which is expressly incorporated by reference herein in its entirety.

### BACKGROUND

1. Field

Certain aspects of the disclosure generally relate to wireless communications and, more particularly, to techniques for enabling coordinated multipoint (CoMP) operations for paging and idle mode operations.

2. Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Telecommunications System (UMTS) mobile standard promulgated by Third Generation Partnership Project (3GPP). It is designed to better support mobile broadband Internet access by improving spectral efficiency, lower costs, improve services, make use of new spectrum, and better integrate with other open standards using OFDMA on the downlink (DL), SC-FDMA on the uplink (UL), and multiple-input multiple-output (MIMO) antenna technology. However, as the demand for mobile broadband access continues to increase, there exists a need for further improvements in LTE technology. Preferably, these improvements should be applicable to other multi-access technologies and the telecommunication standards that employ these technologies.

### SUMMARY

Certain aspects of the present disclosure provide a method for wireless communications. The method generally includes receiving a system information block (SIB) with an indication of a coordinated multipoint (CoMP) identification linked to one or more channel state information reference signal (CSI-RS) ports from a plurality of nodes, and monitoring signals transmitted on the CSI-RS ports linked to the CoMP identification.

Certain aspects provide an apparatus for wireless communications. The apparatus generally includes logic for receiving a SIB with an indication of a CoMP identification linked to one or more CSI-RS ports from a plurality of nodes, and logic for monitoring signals transmitted on the CSI-RS ports linked to the CoMP identification.

Certain aspects provide an apparatus for wireless communications. The apparatus generally includes means for receiving a SIB with an indication of a CoMP identification linked to one or more CSI-RS ports from a plurality of nodes, and means for monitoring signals transmitted on the CSI-RS ports linked to the CoMP identification.

Certain aspects provide a computer-program product for wireless communications, comprising a computer-readable medium having instructions stored thereon, the instructions being executable by one or more processors. The instructions generally include instructions for receiving a SIB with an indication of a CoMP identification linked to one or more CSI-RS ports from a plurality of nodes, and instructions for monitoring signals transmitted on the CSI-RS ports linked to the CoMP identification.

Certain aspects of the present disclosure provide a method for wireless communications. The method generally includes receiving a SIB with an indication of a CoMP identification linked to a plurality of nodes, detecting one or more nodes of the plurality of nodes linked to the CoMP identification, measuring a reference signal received power (RSRP) of each of the one or more nodes, and determining a CoMP RSRP based on the measured RSRP of each of the one or more nodes.

Certain aspects provide an apparatus for wireless communications. The apparatus generally includes logic for receiving a SIB with an indication of a CoMP identification linked to a plurality of nodes, logic for detecting one or more nodes of the plurality of nodes linked to the CoMP identification, logic for measuring a RSRP of each of the one or more nodes, and logic for determining a CoMP RSRP based on the measured RSRP of each of the one or more nodes.

Certain aspects provide an apparatus for wireless communications. The apparatus generally includes means for receiving a SIB with an indication of a CoMP identification linked to a plurality of nodes, means for detecting one or more nodes of the plurality of nodes linked to the CoMP identification, means for measuring a RSRP of each of the one or more nodes, and means for determining a CoMP RSRP based on the measured RSRP of each of the one or more nodes.

Certain aspects provide a computer-program product for wireless communications, comprising a computer-readable medium having instructions stored thereon, the instructions being executable by one or more processors. The instructions generally include instructions for receiving a SIB with an indication of a CoMP identification linked to a plurality of nodes, instructions for detecting one or more nodes of the plurality of nodes linked to the CoMP identification, instructions for measuring a RSRP of each of the one or more nodes, and instructions for determining a CoMP RSRP based on the measured RSRP of each of the one or more nodes.

Certain aspects of the present disclosure provide a method for wireless communications. The method generally includes transmitting, by a wireless node, a SIB with an indication of a CoMP identification linked to one or more CSI-RS ports, and transmitting signals on the linked CSI-RS ports.

Certain aspects provide an apparatus for wireless communications. The apparatus generally includes logic for transmitting, by a wireless node, a SIB with an indication of a CoMP identification linked to one or more CSI-RS ports, and logic for transmitting signals on the linked CSI-RS ports.

Certain aspects provide an apparatus for wireless communications. The apparatus generally includes means for transmitting, by a wireless node, a SIB with an indication of a CoMP identification linked to one or more CSI-RS ports, and means for transmitting signals on the linked CSI-RS ports.

Certain aspects provide a computer-program product for wireless communications, comprising a computer-readable medium having instructions stored thereon, the instructions being executable by one or more processors. The instructions generally include instructions for transmitting, by a wireless node, a SIB with an indication of a CoMP identification linked to one or more CSI-RS ports, and instructions for transmitting signals on the linked CSI-RS ports.

### BRIEF DESCRIPTION OF THE DRAWINGS

FIG. 1 is a diagram illustrating an example of a hardware implementation for an apparatus employing a processing system, in accordance with certain aspects of the present disclosure.

FIG. 2 is a diagram illustrating an example of a network architecture, in accordance with certain aspects of the present disclosure.

FIG. 3 is a diagram illustrating an example of an access network, in accordance with certain aspects of the present disclosure.

FIG. 4 is a diagram illustrating an example of a frame structure for use in an access network, in accordance with certain aspects of the present disclosure.

FIG. 5 shows an exemplary format for the UL in LTE, in accordance with certain aspects of the present disclosure.

FIG. 6 is a diagram illustrating an example of a radio protocol architecture for the user and control plane, in accordance with certain aspects of the present disclosure.

FIG. 7 is a diagram illustrating an example of an evolved Node B and user equipment in an access network, in accordance with certain aspects of the present disclosure.

FIG. 8 illustrates a network having a macro node and a number of remote radio heads (RRHs), in accordance with certain aspects of the present disclosure.

FIG. 9 illustrates example operations for enabling CoMP operations for paging and idle mode operations, in accordance with certain aspects of the present disclosure.

FIG. 9A illustrates example components capable of performing the operations illustrated in FIG. 9, in accordance with certain aspects of the present disclosure.

FIG. 10 illustrates example operations for performing CoMP operations for paging and idle mode operations, in accordance with certain aspects of the present disclosure.

FIG. 10A illustrates example components capable of performing the operations illustrated in FIG. 10, in accordance with certain aspects of the present disclosure.

FIG. 11 illustrates example operations for performing post-processing of existing RSRP measurements to generate a new RSRP that corresponds to CoMP transmissions, in accordance with certain aspects of the present disclosure.

FIG. 11A illustrates example components capable of performing the operations illustrated in FIG. 11, in accordance with certain aspects of the present disclosure.

### DETAILED DESCRIPTION

Wireless networks may include remote radio heads (RRHs) for extending the coverage of a macro cell. The macro cell may be connected to the RRHs, for example, by optical fiber, and there may be negligible latency between the macro cell and the RRHs. RRH deployment with different cell specific RS transmissions may create many cell edges, which may present challenges in idle state mobility. Certain aspects of the present disclosure may utilize coordinated multipoint (CoMP) transmissions for idle user equipment (UE) support and, in some aspects, may introduce new radio link monitoring (RLM) techniques. As a result, the techniques presented herein may help achieve better idle mode performance and/or better RLM performance.

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawing by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. The computer-readable medium may be a non-transitory computer-readable medium. A non-transitory computer-readable medium include, by way of example, a magnetic storage device (e.g., hard disk, floppy disk, magnetic strip), an optical disk (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and any other suitable medium for storing software and/or instructions that may be accessed and read by a computer. The computer-readable medium may be resident in the processing system, external to the processing system, or distributed across multiple entities including the processing system. The computer-readable medium may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

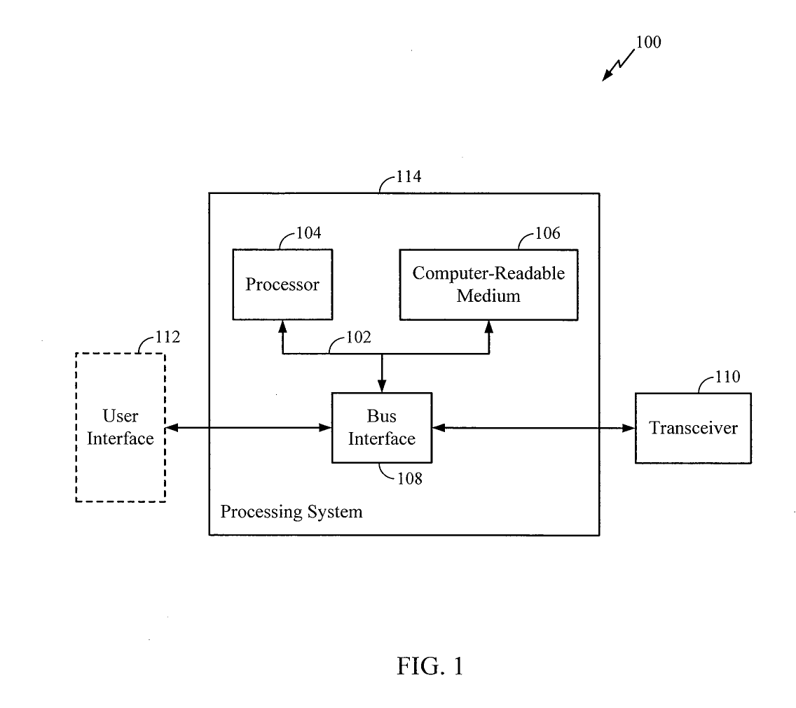

FIG. 1 is a conceptual diagram illustrating an example of a hardware implementation for an apparatus 100 employing a processing system 114. In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors, represented generally by the processor 104, and computer-readable media, represented generally by the computer-readable medium 106. The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 provides a means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

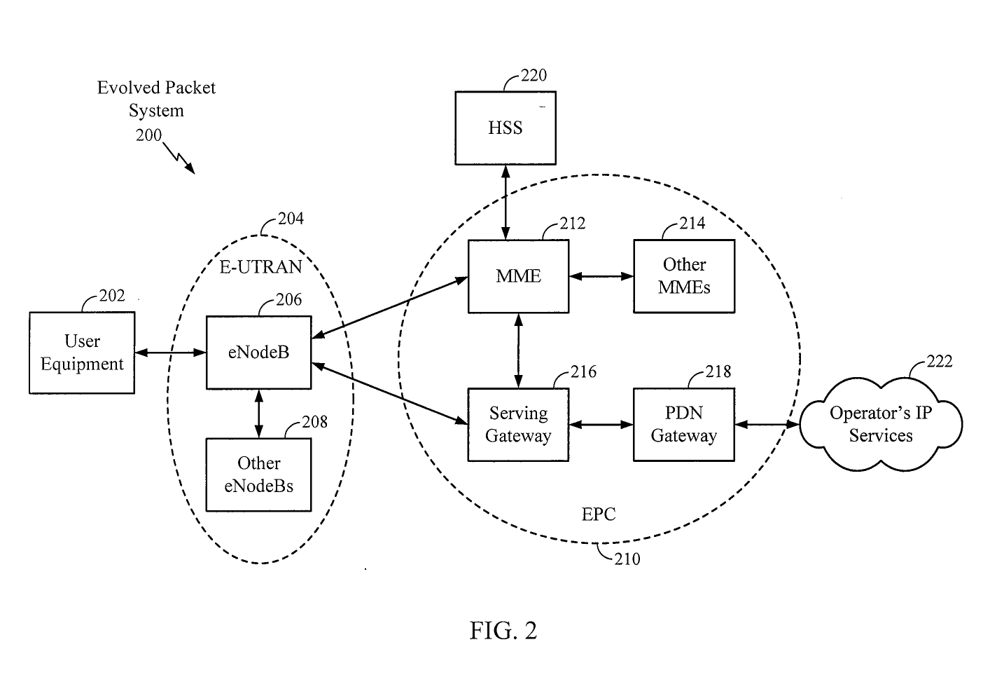

FIG. 2 is a diagram illustrating an LTE network architecture 200 employing various apparatuses 100 (See FIG. 1). The LTE network architecture 200 may be referred to as an Evolved Packet System (EPS) 200. The EPS 200 may include one or more user equipment (UE) 202, an Evolved UMTS Terrestrial Radio Access Network (E-UTRAN) 204, an Evolved Packet Core (EPC) 210, a Home Subscriber Server (HSS) 220, and an Operator's IP Services 222. The EPS can interconnect with other access networks, but for simplicity, those entities/interfaces are not shown. As shown, the EPS provides packet-switched services, however, as those skilled in the art will readily appreciate, the various concepts presented throughout this disclosure may be extended to networks providing circuit-switched services.

The E-UTRAN includes the evolved Node B (eNB) 206 and other eNBs 208. The eNB 206 provides user and control plane protocol terminations toward the UE 202. The eNB 206 may be connected to the other eNBs 208 via an X2 interface (i.e., backhaul). The eNB 206 may also be referred to by those skilled in the art as a base station, a base transceiver station, a radio base station, a radio transceiver, a transceiver function, a basic service set (BSS), an extended service set (ESS), or some other suitable terminology. The eNB 206 provides an access point to the EPC 210 for a UE 202. Examples of UEs 202 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 202 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 206 is connected by an S1 interface to the EPC 210. The EPC 210 includes a Mobility Management Entity (MME) 212, other MMEs 214, a Serving Gateway 216, and a Packet Data Network (PDN) Gateway 218. The MME 212 is the control node that processes the signaling between the UE 202 and the EPC 210. Generally, the MME 212 provides bearer and connection management. All user IP packets are transferred through the Serving Gateway 216, which itself is connected to the PDN Gateway 218. The PDN Gateway 218 provides UE IP address allocation as well as other functions. The PDN Gateway 218 is connected to the Operator's IP Services 222. The Operator's IP Services 222 include the Internet, the Intranet, an IP Multimedia Subsystem (IMS), and a PS Streaming Service (PSS).

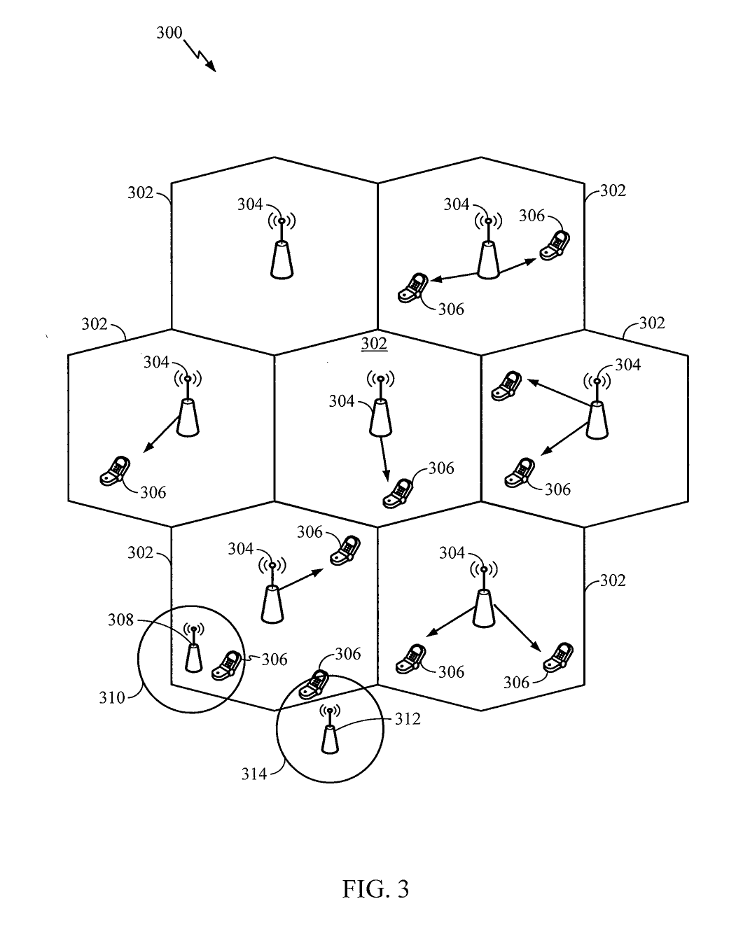

FIG. 3 is a diagram illustrating an example of an access network in an LTE network architecture. In this example, the access network 300 is divided into a number of cellular regions (cells) 302. One or more lower power class eNBs 308, 312 may have cellular regions 310, 314, respectively, that overlap with one or more of the cells 302. The lower power class eNBs 308, 312 may be femto cells (e.g., home eNBs (HeNBs)), pico cells, or micro cells. A higher power class or macro eNB 304 is assigned to a cell 302 and is configured to provide an access point to the EPC 210 for all the UEs 306 in the cell 302. There is no centralized controller in this example of an access network 300, but a centralized controller may be used in alternative configurations. The eNB 304 is responsible for all radio related functions including radio bearer control, admission control, mobility control, scheduling, security, and connectivity to the serving gateway 216 (see FIG. 2).

The modulation and multiple access scheme employed by the access network 300 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNB 304 may have multiple antennas supporting MIMO technology. The use of MIMO technology enables the eNB 304 to exploit the spatial domain to support spatial multiplexing, beamforming, and transmit diversity.

Spatial multiplexing may be used to transmit different streams of data simultaneously on the same frequency. The data steams may be transmitted to a single UE 306 to increase the data rate or to multiple UEs 306 to increase the overall system capacity. This is achieved by spatially precoding each data stream (i.e., applying a scaling of an amplitude and a phase) and then transmitting each spatially precoded stream through multiple transmit antennas on the downlink. The spatially precoded data streams arrive at the UE(s) 306 with different spatial signatures, which enables each of the UE(s) 306 to recover the one or more data streams destined for that UE 306. On the uplink, each UE 306 transmits a spatially precoded data stream, which enables the eNB 304 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the downlink. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The uplink may use SC-FDMA in the form of a DFT-spread OFDM signal to compensate for high peak-to-average power ratio (PARR).

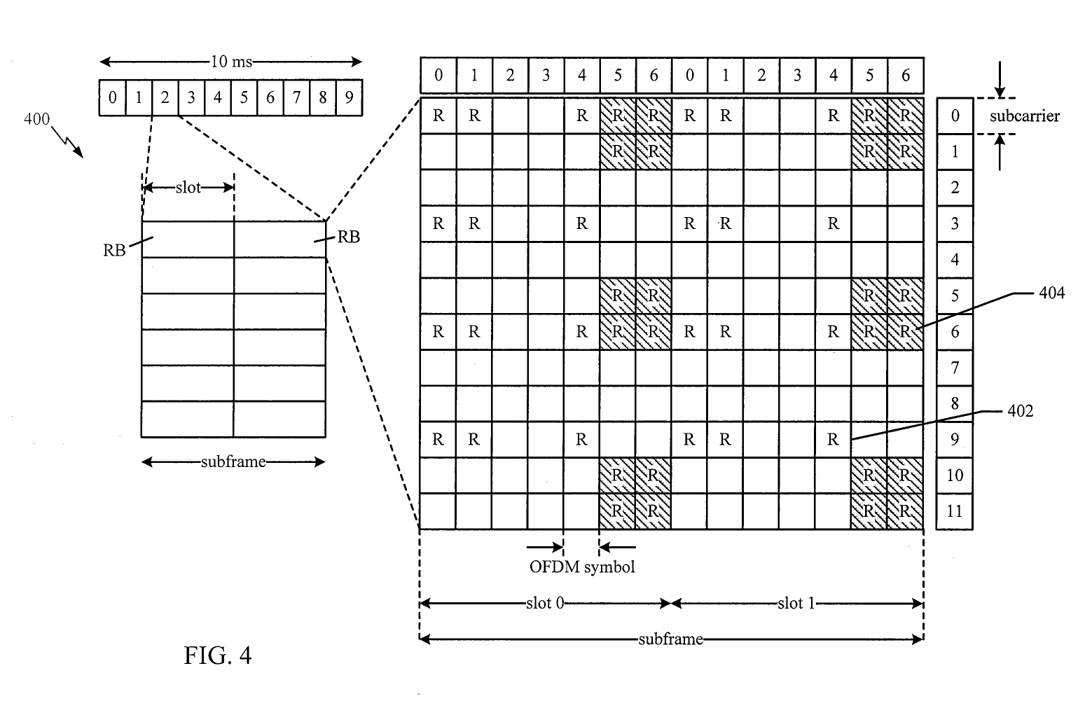

Various frame structures may be used to support the DL and UL transmissions. An example of a DL frame structure will now be presented with reference to FIG. 4. However, as those skilled in the art will readily appreciate, the frame structure for any particular application may be different depending on any number of factors. In this example, a frame (10 ms) is divided into 10 equally sized sub-frames. Each sub-frame includes two consecutive time slots.

A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. Some of the resource elements, as indicated as R 402, 404, include DL reference signals (DL-RS). The DL-RS include cell-specific RS (CRS) (also sometimes called common RS) 402 and UE-specific RS (UE-RS) 404. UE-RS 404 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

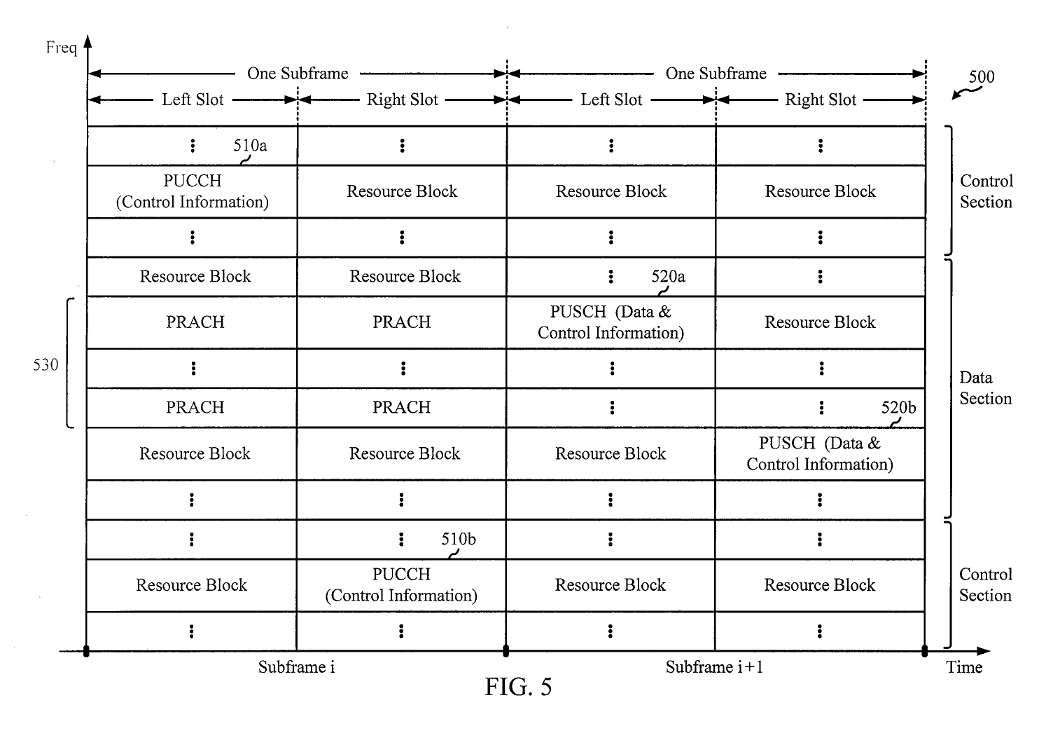

An example of a UL frame structure 500 will now be presented with reference to FIG. 5. FIG. 5 shows an exemplary format for the UL in LTE. The available resource blocks for the UL may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The design in FIG. 5 results in the data section including contiguous subcarriers, which may allow a single UE to be assigned all of the contiguous subcarriers in the data section.

A UE may be assigned resource blocks 510a, 510b in the control section to transmit control information to an eNB. The UE may also be assigned resource blocks 520a, 520b in the data section to transmit data to the eNB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. A UL transmission may span both slots of a subframe and may hop across frequency as shown in FIG. 5.

As shown in FIG. 5, a set of resource blocks may be used to perform initial system access and achieve UL synchronization in a physical random access channel (PRACH) 530. The PRACH 530 carries a random sequence and cannot carry any UL data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) and a UE can make only a single PRACH attempt per frame (10 ms).

The PUCCH, PUSCH, and PRACH in LTE are described in 3GPP TS 36.211, entitled “Evolved Universal Terrestrial Radio Access (E-UTRA); Physical Channels and Modulation,” which is publicly available.

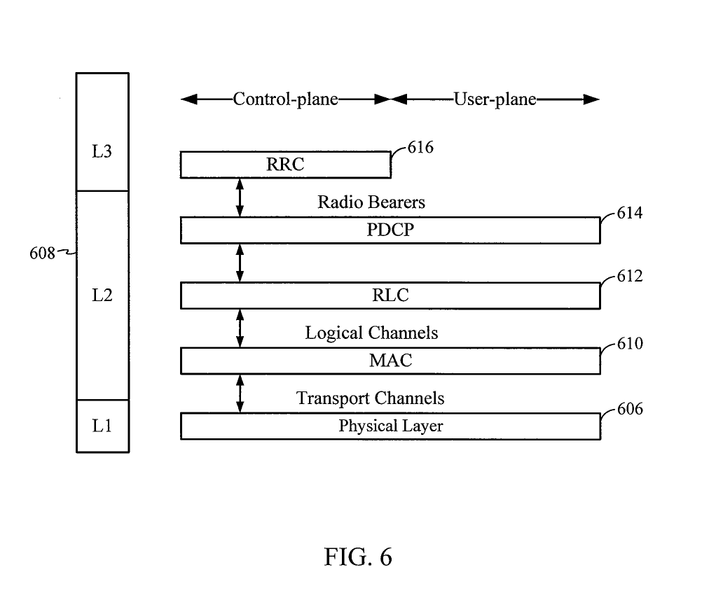

The radio protocol architecture may take on various forms depending on the particular application. An example for an LTE system will now be presented with reference to FIG. 6. FIG. 6 is a conceptual diagram illustrating an example of the radio protocol architecture for the user and control planes.

Turning to FIG. 6, the radio protocol architecture for the UE and the eNB is shown with three layers: Layer 1, Layer 2, and Layer 3. Layer 1 is the lowest layer and implements various physical layer signal processing functions. Layer 1 will be referred to herein as the physical layer 606. Layer 2 (L2 layer) 608 is above the physical layer 606 and is responsible for the link between the UE and eNB over the physical layer 606.

In the user plane, the L2 layer 608 includes a media access control (MAC) sublayer 610, a radio link control (RLC) sublayer 612, and a packet data convergence protocol (PDCP) 614 sublayer, which are terminated at the eNB on the network side. Although not shown, the UE may have several upper layers above the L2 layer 608 including a network layer (e.g., IP layer) that is terminated at the PDN gateway 218 (see FIG. 2) on the network side, and an application layer that is terminated at the other end of the connection (e.g., far end UE, server, etc.).

The PDCP sublayer 614 provides multiplexing between different radio bearers and logical channels. The PDCP sublayer 614 also provides header compression for upper layer data packets to reduce radio transmission overhead, security by ciphering the data packets, and handover support for UEs between eNBs. The RLC sublayer 612 provides segmentation and reassembly of upper layer data packets, retransmission of lost data packets, and reordering of data packets to compensate for out-of-order reception due to hybrid automatic repeat request (HARQ). The MAC sublayer 610 provides multiplexing between logical and transport channels. The MAC sublayer 610 is also responsible for allocating the various radio resources (e.g., resource blocks) in one cell among the UEs. The MAC sublayer 610 is also responsible for HARQ operations.

In the control plane, the radio protocol architecture for the UE and eNB is substantially the same for the physical layer 606 and the L2 layer 608 with the exception that there is no header compression function for the control plane. The control plane also includes a radio resource control (RRC) sublayer 616 in Layer 3. The RRC sublayer 616 is responsible for obtaining radio resources (i.e., radio bearers) and for configuring the lower layers using RRC signaling between the eNB and the UE.

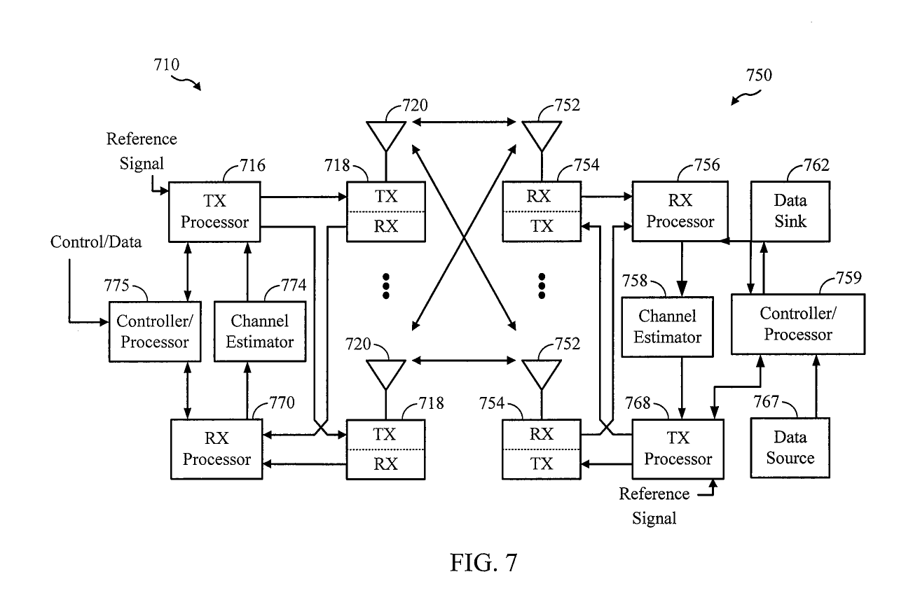

FIG. 7 is a block diagram of an eNB 710 in communication with a UE 750 in an access network. In the DL, upper layer packets from the core network are provided to a controller/processor 775. The controller/processor 775 implements the functionality of the L2 layer described earlier in connection with FIG. 6. In the DL, the controller/processor 775 provides header compression, ciphering, packet segmentation and reordering, multiplexing between logical and transport channels, and radio resource allocations to the UE 750 based on various priority metrics. The controller/processor 775 is also responsible for HARQ operations, retransmission of lost packets, and signaling to the UE 750.

The TX processor 716 implements various signal processing functions for the L1 layer (i.e., physical layer). The signal processing functions includes coding and interleaving to facilitate forward error correction (FEC) at the UE 750 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 774 may be used to determine the coding and modulation scheme, as well as for spatial processing. The channel estimate may be derived from a reference signal and/or channel condition feedback transmitted by the UE 750. Each spatial stream is then provided to a different antenna 720 via a separate transmitter 718TX. Each transmitter 718TX modulates an RF carrier with a respective spatial stream for transmission.

At the UE 750, each receiver 754RX receives a signal through its respective antenna 752. Each receiver 754RX recovers information modulated onto an RF carrier and provides the information to the receiver (RX) processor 756.

The RX processor 756 implements various signal processing functions of the L1 layer. The RX processor 756 performs spatial processing on the information to recover any spatial streams destined for the UE 750. If multiple spatial streams are destined for the UE 750, they may be combined by the RX processor 756 into a single OFDM symbol stream. The RX processor 756 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 710. These soft decisions may be based on channel estimates computed by the channel estimator 758. The soft decisions are then decoded and deinterleaved to recover the data and control signals that were originally transmitted by the eNB 710 on the physical channel. The data and control signals are then provided to the controller/processor 759.

The controller/processor 759 implements the L2 layer described earlier in connection with FIG. 6. In the UL, the controller/processor 759 provides demultiplexing between transport and logical channels, packet reassembly, deciphering, header decompression, control signal processing to recover upper layer packets from the core network. The upper layer packets are then provided to a data sink 762, which represents all the protocol layers above the L2 layer. Various control signals may also be provided to the data sink 762 for L3 processing. The controller/processor 759 is also responsible for error detection using an acknowledgement (ACK) and/or negative acknowledgement (NACK) protocol to support HARQ operations.

In the UL, a data source 767 is used to provide upper layer packets to the controller/processor 759. The data source 767 represents all protocol layers above the L2 layer (L2). Similar to the functionality described in connection with the DL transmission by the eNB 710, the controller/processor 759 implements the L2 layer for the user plane and the control plane by providing header compression, ciphering, packet segmentation and reordering, and multiplexing between logical and transport channels based on radio resource allocations by the eNB 710. The controller/processor 759 is also responsible for HARQ operations, retransmission of lost packets, and signaling to the eNB 710.

Channel estimates derived by a channel estimator 758 from a reference signal or feedback transmitted by the eNB 710 may be used by the TX processor 768 to select the appropriate coding and modulation schemes, and to facilitate spatial processing. The spatial streams generated by the TX processor 768 are provided to different antenna 752 via separate transmitters 754TX. Each transmitter 754TX modulates an RF carrier with a respective spatial stream for transmission.

The UL transmission is processed at the eNB 710 in a manner similar to that described in connection with the receiver function at the UE 750. Each receiver 718RX receives a signal through its respective antenna 720. Each receiver 718RX recovers information modulated onto an RF carrier and provides the information to a RX processor 770. The RX processor 770 implements the L1 layer.

The controller/processor 759 implements the L2 layer described earlier in connection with FIG. 6. In the UL, the controller/processor 759 provides demultiplexing between transport and logical channels, packet reassembly, deciphering, header decompression, control signal processing to recover upper layer packets from the UE 750. Upper layer packets from the controller/processor 775 may be provided to the core network. The controller/processor 759 is also responsible for error detection using an ACK and/or NACK protocol to support HARQ operations.

The processing system 114 described in relation to FIG. 1 includes the eNB 710. In particular, the processing system 114 includes the TX processor 716, the RX processor 770, and the controller/processor 775. The processing system 114 may further include RRHs to which the eNB 710 is coupled. The processing system 114 described in relation to FIG. 1 includes the UE 750. In particular, the processing system 114 includes the TX processor 768, the RX processor 756, and the controller/processor 759.

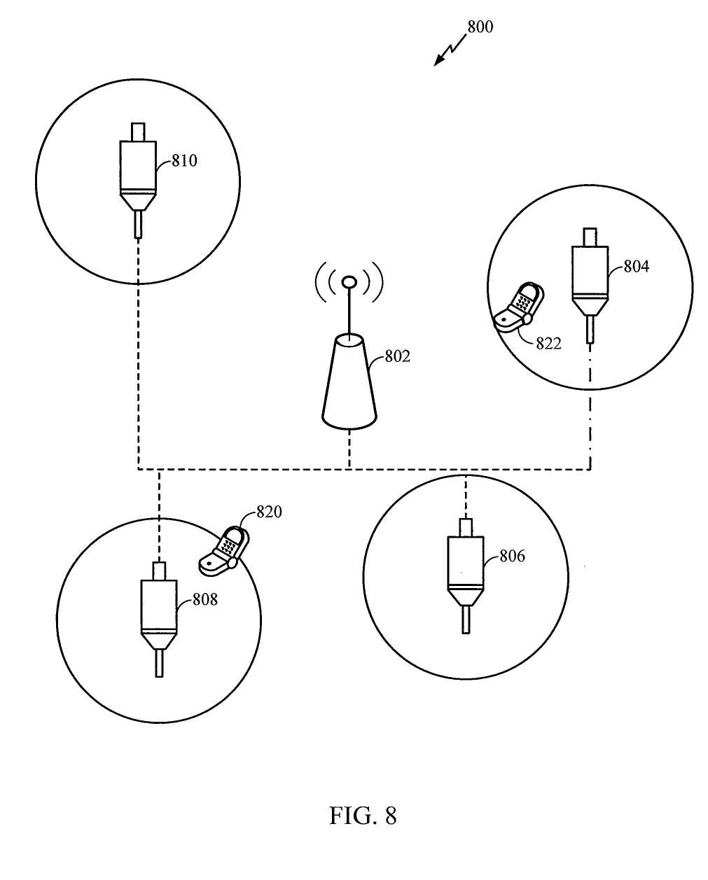

FIG. 8 illustrates a network 800 having a macro node and a number of remote radio heads (RRHs), in accordance with certain aspects of the present disclosure. The macro node 802 may be connected to RRHs 804, 806, 808, 810 with optical fiber. In certain aspects, network 800 may be a homogeneous network or a heterogeneous network and the RRHs 804-810 may be low power or high power RRHs. In an aspect, the macro node 802 handles all scheduling within the cell, for itself and the RRHs. The RRHs may be configured with the same cell identifier (ID) as the macro node 802 or with different cell IDs. If the RRHs are configured with the same cell ID, the macro node 802 and the RRHs may operate as essentially one cell controlled by the macro node 802. On the other hand, if the RRHs and the macro node 802 are configured with different cell IDs, the macro node 802 and the RRHs may appear to a UE as different cells, though all control and scheduling may still remain with the macro node 802.

In certain aspects, heterogeneous setups may show the most performance benefit for advanced UEs (e.g., UEs for LTE Rel-10 or greater) receiving data transmission from RRH/nodes. A key difference between setups is typically related to control signaling and handling of legacy impact. In an aspect, each of the RRHs may be assigned to transmit on one or more CSI-RS ports. In general, the macro node and RRHs may be assigned a subset of the CSI-RS ports. For example, if there are 8 available CSI-RS ports, RRH 804 may be assigned to transmit on CSI-RS ports 0, 1, RRH 806 may be assigned to transmit on CSI-RS ports 2, 3, RRH 808 may be assigned to transmit on CSI-RS ports 4, 5, and RRH 810 may be assigned to transmit on CSI-RS ports 6, 7. The macro node and/or the RRHs may be assigned the same CSI-RS ports. For example, RRH 804 and RRH 808 may be assigned to transmit on CSI-RS ports 0, 1, 2, 3, and RRH 806 and RRH 810 may be assigned to transmit on CSI-RS ports 4, 5, 6, 7. In such a configuration, the CSI-RS from RRHs 804, 808 would overlap and the CSI-RS from RRHs 806, 810 would overlap.

The CSI-RS is typically UE-specific. Each UE may be configured with up to a predetermined number of CSI-RS ports (e.g., 8 CSI-RS ports) and may receive CSI-RS on the CSI-RS ports from one or more of the RRHs 804-810. For example, the UE 820 may receive CSI-RS on CSI-RS ports 0, 1 from RRH 804, CSI-RS on CSI-RS ports 2, 3 from RRH 806, CSI-RS on CSI-RS ports 4, 5 from RRH 808, and CSI-RS on CSI-RS ports 6, 7 from RRH 810. Such a configuration is typically specific to the UE 820, as the UE 820 may receive CSI-RS on different ports from the same RRHs. For example, the UE 822 may also be configured with 8 CSI-RS ports and receive CSI-RS on CSI-RS ports 0, 1 from RRH 808, CSI-RS on CSI-RS ports 2, 3 from RRH 810, CSI-RS on CSI-RS ports 4, 5 from RRH 804, and CSI-RS on CSI-RS ports 6, 7 from RRH 806. Generally, for any particular UE, the CSI-RS ports may be distributed among the RRHs and the particular UE may be configured with any number of the CSI-RS ports to receive CSI-RS on those ports from RRHs configured to send on those ports to the particular UE.

In certain aspects, when each of the RRHs share the same cell ID with the macro node 802, control information may be transmitted using CRS from the macro node or both the macro node and all of the RRHs. The CRS is typically transmitted from each of the transmission/reception points (i.e., macro node, RRHs) (a transmission/reception point is herein referred to as “TxP”) using the same resource elements, and therefore the signals are on top of each other. In certain aspects, the term transmission/reception point (“TxP”) typically represents geographically separated transmission/reception nodes which are being controlled by at least one central entity (e.g., eNodeB) and may have the same or different cell IDs. When each of the TxPs has the same cell ID, CRS transmitted from each of the TxPs may not be differentiated. In certain aspects, when the RRHs have different cell IDs, the CRS transmitted from each of the TxPs using the same resource elements may collide. In an aspect, when the RRHs have different cell IDs and the CRS collide, CRS transmitted from each of the TxPs may be differentiated by interference cancellation techniques and advanced receiver processing.

In certain aspects, when CRS is transmitted from multiple TxPs, proper antenna virtualization is needed if there are an unequal number of physical antennas at the transmitting macro node/RRHs. That is, CRS may be transmitted from an equal number of (virtual) transmit antennas at each macro node and RRH. For example, if the node 802 and the RRHs 804, 806, 808 each have two physical antennas and the RRH 810 has four physical antennas, a first two antennas of the RRH 810 may be configured to transmit CRS port 0 and a second two antennas of the RRH 810 may be configured to transmit CRS port 1. The number of antenna ports may be increased or decreased in relation to the number of physical antennas.

As discussed supra, the macro node 802 and the RRHs 804-810 may all transmit CRS. However, if only the macro node 802 transmits CRS, an outage may occur close to an RRH due to automatic gain control (AGC) issues. Typically, a difference between same/different cell ID setups is mainly related to control and legacy issues and other potential operations relying on CRS. The scenario with different cell IDs, but colliding CRS configuration may have similarities with the same cell ID setup, which by definition has colliding CRS. The scenario with different cell IDs and colliding CRS typically has the advantage compared to the same cell ID case that system characteristics/components which depend on the cell ID (e.g., scrambling sequences, etc.) may be more easily differentiated.

As discussed supra, UEs may receive data transmissions with CSI-RS and may provide CSI feedback. An issue is that the existing codebooks were designed assuming that the path loss for each of the CSI-RS is equal and may therefore suffer some performance loss if this condition is not satisfied. Because multiple RRHs may be transmitting data with CSI-RS, the path loss associated with each of the CSI-RS may be different. As such, codebook refinements may be needed to enable cross TxP CSI feedback that takes into account the proper path losses to TxPs. Multiple CSI feedback may be provided by grouping antenna ports and providing feedback per group.

The exemplary configurations are applicable to macro/RRH setups with same or different cell IDs. In the case of different cell IDs, CRS may be configured to be overlapping, which may lead to a similar scenario as the same cell ID case (but has the advantage that system characteristics which depend on the cell ID (e.g., scrambling sequences, etc.) may be more easily differentiated by the UE).

In certain aspects, an exemplary macro/RRH entity may provide for separation of control/data transmissions within the coverage of a macro/RRH setup. When the cell ID is the same for each TxP, the PDCCH may be transmitted with CRS from the macro node 802 or both the macro node 802 and the RRHs, while the PDSCH may be transmitted with CSI-RS and DM-RS from a subset of the TxPs. When the cell ID is different for some of the TxPs, PDCCH may be transmitted with CRS in each cell ID group. The CRS transmitted from each cell ID group may or may not collide. UEs may not differentiate CRS transmitted from multiple TxPs with the same cell ID, but may differentiate CRS transmitted from multiple TxPs with different cell IDs (e.g., using interference cancellation or similar techniques). The separation of control/data transmissions enables a UE a transparent way of “associating” UEs with at least one TxP for data transmission while transmitting control based on CRS transmissions from all the TxPs. This enables cell splitting for data transmission across different TxPs while leaving the control channel common. The term “association” above means the configuration of antenna ports for a specific UE for data transmission. This is different from the association that would be performed in the context of handover. Control may be transmitted based on CRS as discussed supra. Separating control and data may allow for a faster reconfiguration of the antenna ports that are used for a UE's data transmission compared to having to go through a handover process. In certain aspects, cross TxP feedback may be possible by configuring a UE's antenna ports to correspond to the physical antennas of different TxPs.

In certain aspects, UE-specific reference signals enable this operation (e.g., in the context of LTE-A, Rel-10 and above). CSI-RS and DM-RS are the reference signals used in the LTE-A context. Interference estimation may be carried out based on CSI-RS muting. With common control, there may be control capacity issues because PDCCH capacity may be limited. Control capacity may be enlarged by using FDM control channels. Relay PDCCH (R-PDCCH) or extensions thereof may be used to supplement, augment, or replace the PDCCH control channel. The UE may provide CSI feedback based on its CSI-RS configuration to provide PMI/RI/CQI. The codebook design may assume that the antennas are not geographically separated, and therefore that there is the same path loss from the antenna array to the UE. This is not the case for multiple RRHs, as the antennas are uncorrelated and see different channels. Codebook refinements may enable more efficient cross TxP CSI feedback. CSI estimation may capture the path loss difference between the antenna ports associated with different TxPs. Furthermore, multiple feedback may be provided by grouping antenna ports and provided feedback peer group.

### Radio Resource Monitoring (RRM) and Radio Link Monitoring (RLM) Procedures for Remote Radio Head RRH) Deployments

RRH deployment with different cell specific RS transmissions may create many cell edges, which may present challenges in idle state mobility. For example, in idle state, a UE in an RRH deployment with different cell identifications may have to perform an increased number of searches due to increased cell boundaries, which may result in a reduced battery life of the UE. Certain aspects of the present disclosure, however, may utilize coordinated multipoint (CoMP) transmissions for idle UE support and, in some aspects, may introduce new RLM techniques. As a result, the techniques presented herein may help achieve better idle mode performance and/or better RLM performance.

As described above, RRHs generally refer to remotely located antenna systems and RF units of a macro base station (e.g., eNB). As noted above, the backhaul, in some cases, may be fiber-connected, yielding high capacity throughput (e.g., 100 Mbps) and low latency (e.g., on the order of 1 μs).

There are typically two types of RRH deployments. In a first deployment, RRHs may share the same cell ID with one of the connected macro cells, known as a single frequency network (SFN). In this case, RRHs are simply a distributed antenna system of the macro cell that may be transparent to Rel-8/9/10 UEs. For later release UEs that are aware of CoMP operation, the RRHs may be differentiated as different transmission points. In this case, no legacy mobility procedures may be required as the UE travels between the RRHs and the macro cell. There may be a default assumption that all RRHs transmit the same CRS antenna ports as the macro.

However, for another type of deployment, RRHs may be differentiated, with different cell IDs. In this case, each RRH may be differentiated by the UEs and mobility procedures may apply. In other words, as the UE travels between the RRHs and the eNB, handover or cell reselection may be required.

In idle mode, a UE typically performs various functions, such as monitoring paging activity from the serving cell. If paged, the UE typically transitions to a connected state, measures the serving cell signal quality and, if not at a certain threshold, switches to a better cell and registers to new paging areas.

It is often likely that RRHs and a connected macro cell will have the same paging area. In this case, with RRHs sharing a same Cell ID, there may be no need for reconfiguration of the paging area. However, if RRHs have different cell IDs, a reconfiguration of the paging area may be performed, for example, thereby including the RRHs into the macro cell paging area. Backhaul load and paging capacity is likely to be the same in both cases. Different cell IDs allow additional optimization of smaller macro cell paging areas and higher capacity if needed. However, paging reliability may be better with the same Cell ID due to the SFN operation.

In idle state, a UE may make various radio resource management (RRM) measurements, such as reference signal received power (RSRP) and reference signal received quality (RSRQ) measurements. RSRP and RSRQ are typically defined based on the strongest CRS antenna ports. For same cell ID setups, this may lead to an effective SFN, with a better signal-to-noise ratio (SNR) across the macro cell coverage area. In this case, RSRP and RSRQ may both be high within the coverage area due to, for example, the contribution of the signal from both the macro cell and connected RRHs. This may result in fewer searches triggered (e.g., due to the addition of RRHs with the same cell ID) compared to macro only deployments, and possibly better battery consumption. RSRP may be used for mobility between macro cell areas.

For RRH deployment with different cell ID setups, RSRQ may need to be used for mobility procedures, since RSRP may not reflect the true channel condition. For Rel-8 UEs, this may not work, since RSRQ is not defined in idle state. For Rel-9 UEs, these UEs may have a higher number of searches due to increased cell boundaries (i.e., for each RRH with its own cell ID). Rel-10 UEs with inter-cell interference coordination (ICIC), via TDM partitioning of resources between the macro cell and connected RRHs, may have potentially fewer searches due to high RSRQ on almost blank subframes (ABS). However, the TDM partitioning of resources may not be available for Rel-10 UEs in idle mode, which may result in a higher number of searches, as for Rel-9 UEs. The higher number of searches may result in a reduced battery life of the UE.

Therefore, techniques are provided that may allow for fewer searches/reselections in idle mode and an improved battery life. The techniques may take advantage of the observation that an SFN may be considered as a special form of CoMP. In other words, a macro cell and connected RRHs having different cell IDs may be considered as a single cell. Thus, by enabling CoMP operations (between the RRHs and the macro cell) for paging and idle mode operations, improvements may be achieved.

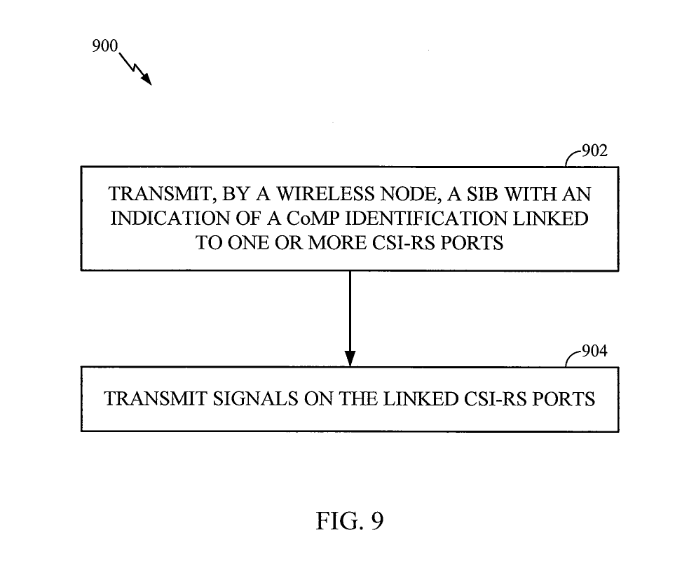

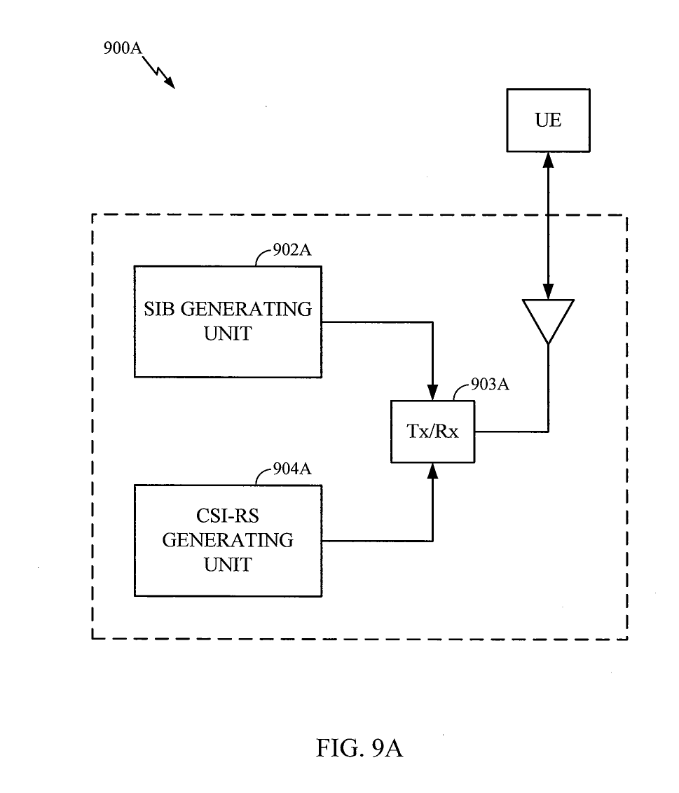

FIG. 9 illustrates example operations 900 for enabling CoMP operations for paging and idle mode operations, in accordance with certain aspects of the present disclosure. The operations 900 may be performed, for example, by an eNB.

At 902, the eNB may transmit a system information block (SIB) with an indication of a CoMP identification linked to one or more channel state information reference signal (CSI-RS) ports. Types of the SIB generally include a master information block (MIB) and SIB1-SIB8.

At 904, the eNB may transmit signals on the linked CSI-RS ports. For certain aspects, the eNB may transmit a broadcast paging transmission as part of a CoMP transmission coordinated with other wireless nodes, wherein the wireless nodes generally includes RRHs with different cell identifications. The CoMP transmission may be a single frequency network (SFN) transmission. For certain aspects, the broadcast paging transmission may be transmitted based on a demodulation reference signal (DM-RS).

The operations 900 described above may be performed by any suitable components or other means capable of performing the corresponding functions of FIG. 9. For example, operations 900 illustrated in FIG. 9 correspond to components 900A illustrated in FIG. 9A. In FIG. 9A, a SIB generating unit 902A may generate a SIB with an indication of a CoMP identification linked to one or more CSI-RS ports. A transceiver (Tx/Rx) 903A may transmit the SIB. A CSI-RS generating unit 904A may generate signals on the linked CSI-RS ports. The Tx/Rx 903A may transmit the signals on the linked CSI-RS ports.

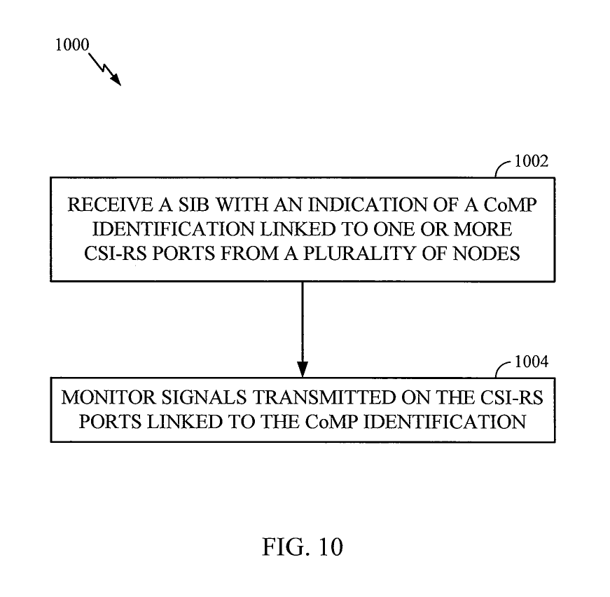

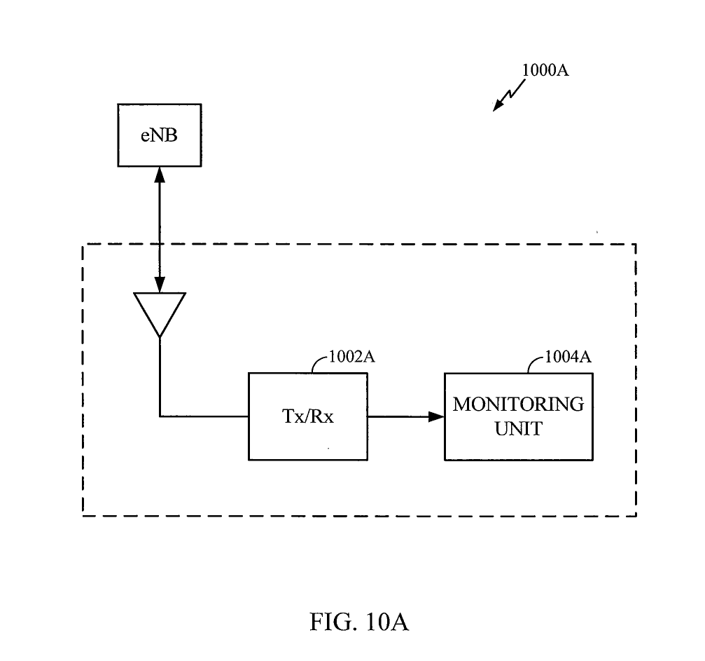

FIG. 10 illustrates example operations 1000 for performing CoMP operations for paging and idle mode operations, in accordance with certain aspects of the present disclosure. The operations 1000 may be performed, for example, by a UE.

At 1002, the UE may receive a SIB with an indication of a CoMP identification linked to one or more CSI-RS ports from a plurality of nodes, wherein the plurality of nodes generally includes RRHs with different cell identifications. The SIB may be received through a CoMP transmission or a unicast transmission.

At 1004, the UE may monitor signals transmitted on the CSI-RS ports linked to the CoMP identification. For certain aspects, monitoring may be performed after entering an idle mode. For certain aspects, the UE may determine a CoMP reference signal received power (RSRP) based on the monitored signals. Thereafter, the UE may perform computing of a CoMP reference signal received quality (RSRQ) as a ratio of the CoMP RSRP to a received signal strength indicator (RSSI).

For certain aspects, the UE may receive, from each of the plurality of nodes, a broadcast paging transmission as part of a CoMP transmission. The UE may access at least one serving cell after receiving the broadcast paging transmission. For certain aspects, accessing the at least one serving cell generally includes searching for the at least one serving cell and transmitting a random access channel (RACH) on a configured channel of the at least one serving cell.

The operations 1000 described above may be performed by any suitable components or other means capable of performing the corresponding functions of FIG. 10. For example, operations 1000 illustrated in FIG. 10 correspond to components 1000A illustrated in FIG. 10A. In FIG. 10A, a Tx/Rx 1002A may receive a SIB with an indication of a CoMP identification linked to one or more CSI-RS ports from a plurality of nodes. A monitoring unit 1004A may monitor signals transmitted on the CSI-RS ports linked to the CoMP identification.

Enabling CoMP operations for paging operations generally includes replacing a PDCCH for a paging-radio network temporary identifier (P-RNTI) with a control channel that may be transmitted from multiple cells, such as the macro cell and connected RRHs. For example, as described above, an enhanced PDCCH (E-PDCCH) similar to Rel-10 relay PDCCH (R-PDCCH) may be used to replace the PDCCH. Therefore, for paging purposes, a downlink (DL)-eNB design may include utilizing an E-PDCCH for the P-RNTI and transmitting broadcast paging transmissions (paging payload) based on a DM-RS. As a result, joint transmissions may be sent from the macro cell and the connected RRHs for the P-RNTI, and be considered as a single CoMP cell. According to certain aspects, a new CoMP ID may be utilized for the P-RNTI, as an indication for the UE to search for the CoMP cell.

For a corresponding DL-UE design, in addition to monitoring a conventional PDCCH for a P-RNTI, an advanced UE may also monitor the above-described E-PDCCH for a P-RNTI. CoMP paging may effectively remove the necessity for cell reselection (between RRH cells) in idle mode, although reselection in connected mode to find the best cell may still be performed. Therefore, when the UE is within the coverage area of the macro cell, the UE may not have to perform reselection to an RRH, due to the joint transmission that the UE receives from the macro cell and connected RRHs. Effectively removing the necessity for cell reselection may improve the battery life of the UE.

For RRM and RLM measurements, techniques may be designed in an effort to ensure reselection only when the CoMP signal to interference plus noise ratio (SINR) is low, for example, at a macro boundary. According to one approach, joint broadcast of a new reference signal (i.e., from the CoMP cell), such as a paging CSI-RS (P-CSI-RS), that corresponds to paging transmission for UE RRM procedures may be used. In this case, modification to an existing CSI-RS may be implemented, for example, by adding a muting pattern not only limited to the configuration of CSI-RS periodicity of 5, 10, 20, 40, and to increase processing gain.

According to another approach, a UE may perform (i.e., receiver-side enhancement) post-processing of existing RSRP measurements to generate a new RSRP that corresponds to the CoMP transmission (i.e., CoMP RSRP).

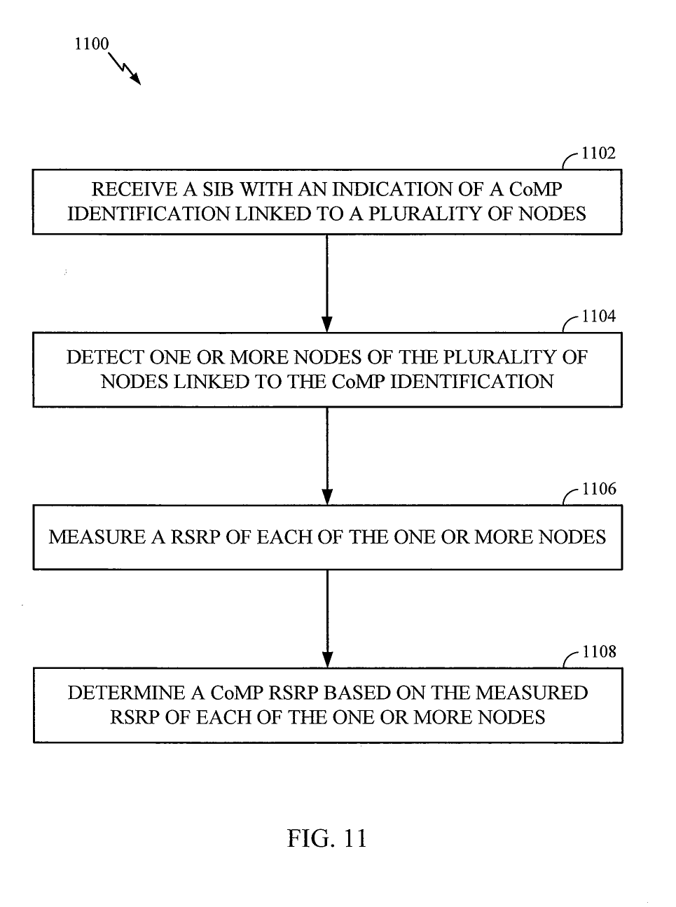

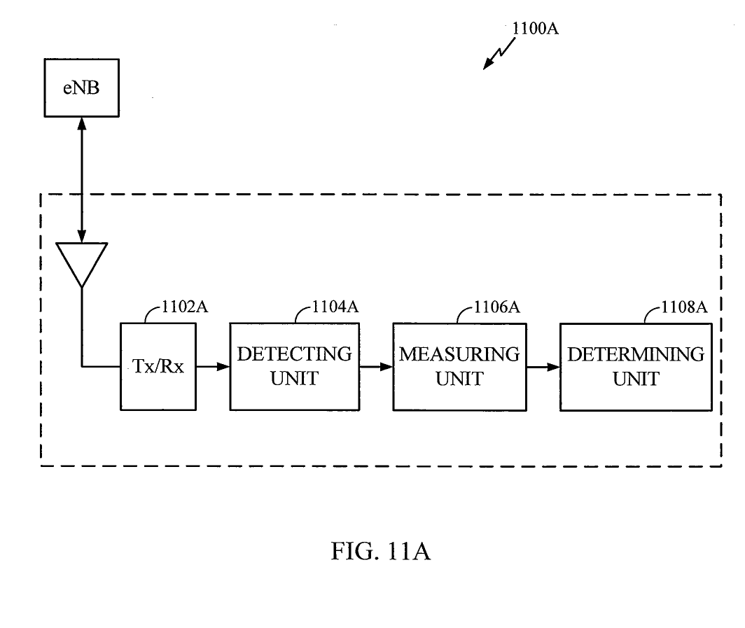

FIG. 11 illustrates example operations 1100 for performing post-processing of existing RSRP measurements to generate a new RSRP that corresponds to CoMP transmissions, in accordance with certain aspects of the present disclosure. The operations 1100 may be performed, for example, by a UE.

At 1102, the UE may receive a SIB with an indication of a CoMP identification linked to a plurality of nodes. At 1104, the UE may detect one or more nodes of the plurality of nodes linked to the CoMP identification. At 1106, the UE may measure a RSRP of each of the one or more nodes. At 1108, the UE may determine a CoMP RSRP based on the measured RSRP of each of the one or more nodes. Thereafter, the UE may compute a CoMP RSRQ as a ratio of the CoMP RSRP to a RSSI.

The operations 1100 described above may be performed by any suitable components or other means capable of performing the corresponding functions of FIG. 11. For example, operations 1100 illustrated in FIG. 11 correspond to components 1100A illustrated in FIG. 11A. In FIG. 11A, a Tx/Rx 1102A may receive a SIB with an indication of a CoMP identification linked to a plurality of nodes. A detecting unit 1104A may detect one or more nodes of the plurality of nodes linked to the CoMP identification. A measuring unit 1106A may measure a RSRP of each of the one or more nodes. A determining unit 1108A may determine a CoMP RSRP based on the measured RSRP of each of the one or more nodes.

For post-processing of existing RSRP measurements, a CoMP ID may include a set of physical cell IDs (PCIs), and the CoMP RSRP and CoMP RSRQ may then be calculated as:

CoMP RSRP=sum(RSRPᵢ),

CoMP RSRQ=CoMP RSRP/RSSI

wherein i is the number of cells in the CoMP set. An advantage to this approach may be that no additional PHY channels may be required for measurements. However, it may be required for the UE to track multiple cells when necessary, so search frequency may not be reduced, but cell reselection may be reduced.

After receiving a page from a macro cell and connected RRHs functioning as a single CoMP cell (as described above), the UE may identify and access a logical serving cell (i.e., revert to unicast operation) by using a random access channel (RACH). According to one approach, upon successful decoding of a page (as described above), the UE may search and acquire a strongest member cell, which may become the new logical serving cell. Therefore, upon receiving the page, the UE may revert to unicast operation by using the RACH to access the strongest member cell. The RACH may be based on the configuration of one of the cells, such as the strongest member cell. This cell may be used for access, which may follow current (e.g., Rel-10) procedures.

According to another approach, upon successful decoding of a page, a UE may search for a RACH on common resources and expect a CoMP transmission/reception. In other words, rather than searching for the strongest member cell, the UE may use the RACH to access the CoMP cell (i.e., the macro cell and connected RRHs) by considering the CoMP cell as a single identity. The RACH may be based on the configuration of the CoMP cell. This approach may require that additional RACH information be broadcast in every cell. After several transmissions between the UE and the CoMP cell, one of the MSGs (e.g., MSG4) may be used to inform the UE of the logical serving cell for control. Therefore, the UE may revert to unicast operation at a later stage after using the RACH to access the CoMP cell.

As described above, various enhancements may be provided for advanced UEs regarding RRM in RRH deployments with different cell IDs. As another example, in initial acquisition operations (i.e., upon power up of a UE), the UE may monitor reference signals linked to a CoMP ID. Initially, the UE may follow a Rel-8 procedure to acquire the strongest cell. The system information block (SIB) of each member cell (e.g., of a CoMP cell) may include information indicating the CoMP ID, which may be linked to some P-CSI-RS ports for monitoring. Moreover, the SIB may carry downlink parameters for reading pages, such as R-PDCCH and P-RNTI configurations. Upon entering idle mode, the UE may begin monitoring signals transmitted on the P-CSI-RS ports (and may be able to differentiate based on the CoMP IDs and linked P-CSI-RS ports). For cell reselection, if a CoMP area starts to degrade, the UE may search for new cells based on CRS. For intra-frequency ranking, a determination may be made regarding how to compare measurements based on CSI-RS and CRS. As there may be no need to strictly rank cells, different metrics may be possible.

Radio Link Monitoring (RLM) is typically a function of SINR on a PDCCH transmission. For example, if the channel quality of a serving cell is below a threshold, the UE may initiate the reselection process for another serving cell. However, RLM may not be usable for controls over R-PDCCH transmissions (e.g., if the R-PDCCH transmission is unicast). According to certain aspects of the present disclosure, for RLM, if R-PDCCH is used, a UE may monitor the R-PDCCH reliability. According to certain aspects, RLM may be based on a corresponding P-CSI-RS, which may be RRC configured for each UE. Moreover, the RLM may be based on the DM-RS configured for the R-PDCCH common search space, which may yield the actual R-PDCCH performance.

Referring to FIG. 1 and FIG. 7, in one configuration, the apparatus 100 for wireless communication includes means for performing the various methods. The aforementioned means is the processing system 114 configured to perform the functions recited by the aforementioned means. As described supra, the processing system 114 includes the TX Processor 716, the RX Processor 770, and the controller/processor 775. As such, in one configuration, the aforementioned means may be the TX Processor 716, the RX Processor 770, and the controller/processor 775 configured to perform the functions recited by the aforementioned means.

In one configuration, the apparatus 100 for wireless communication includes means for performing the various methods. The aforementioned means is the processing system 114 configured to perform the functions recited by the aforementioned means. As described supra, the processing system 114 includes the TX Processor 768, the RX Processor 756, and the controller/processor 759. As such, in one configuration, the aforementioned means may be the TX Processor 768, the RX Processor 756, and the controller/processor 759 configured to perform the functions recited by the aforementioned means.

It is understood that the specific order or hierarchy of steps in the processes disclosed is an illustration of exemplary approaches. Based upon design preferences, it is understood that the specific order or hierarchy of steps in the processes may be rearranged. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method for wireless communications, comprising:
receiving a system information block (SIB) with an indication of a coordinated multipoint (CoMP) identification linked to one or more channel state information reference signal (CSI-RS) ports from a plurality of nodes; and
monitoring signals transmitted on the CSI-RS ports linked to the CoMP identification.

2. The method of claim 1, wherein the monitoring is performed after entering an idle mode.

3. The method of claim 1, wherein the plurality of nodes comprise remote radio heads (RRHs) with different cell identifications.

4. The method of claim 1, further comprising:
determining a CoMP reference signal received power (RSRP) based on the monitored signals.

5. The method of claim 4, further comprising:
computing a CoMP reference signal received quality (RSRQ) as a ratio of the CoMP RSRP to a received signal strength indicator (RSSI).

6. The method of claim 1, further comprising:
receiving, from each of the plurality of nodes, a broadcast paging transmission as part of a CoMP transmission; and
accessing at least one serving cell after receiving the broadcast paging transmission.

7. The method of claim 6, wherein the accessing comprises:
searching for the at least one serving cell; and
transmitting a random access channel (RACH) on a configured channel of the at least one serving cell.

8. The method of claim 7, wherein the RACH is based on a configuration of the at least one serving cell.

9. The method of claim 6, wherein the accessing comprises transmitting a random access channel (RACH) based on a configuration of the plurality of nodes.

10. The method of claim 1, wherein the SIB is received through a CoMP transmission or a unicast transmission.

11. The method of claim 1, wherein the SIB is a master information block (MIB).

12. An apparatus for wireless communications, comprising:
logic for receiving a system information block (SIB) with an indication of a coordinated multipoint (CoMP) identification linked to one or more channel state information reference signal (CSI-RS) ports from a plurality of nodes; and
logic for monitoring signals transmitted on the CSI-RS ports linked to the CoMP identification.

13. The apparatus of claim 12, wherein the monitoring is performed after entering an idle mode.

14. The apparatus of claim 12, wherein the plurality of nodes comprise remote radio heads (RRHs) with different cell identifications.

15. The apparatus of claim 12, further comprising:
logic for determining a CoMP reference signal received power (RSRP) based on the monitored signals.

16. The apparatus of claim 15, further comprising:
logic for computing a CoMP reference signal received quality (RSRQ) as a ratio of the CoMP RSRP to a received signal strength indicator (RSSI).

17. The apparatus of claim 12, further comprising:
logic for receiving, from each of the plurality of nodes, a broadcast paging transmission as part of a CoMP transmission; and
logic for accessing at least one serving cell after receiving the broadcast paging transmission.

18. The apparatus of claim 17, wherein the logic for accessing comprises:
logic for searching for the at least one serving cell; and
logic for transmitting a random access channel (RACH) on a configured channel of the at least one serving cell.

19. The apparatus of claim 18, wherein the RACH is based on a configuration of the at least one serving cell.

20. The apparatus of claim 17, wherein the logic for accessing comprises logic for transmitting a random access channel (RACH) based on a configuration of the plurality of nodes.

21. The apparatus of claim 12, wherein the SIB is received through a CoMP transmission or a unicast transmission.

22. The apparatus of claim 12, wherein the SIB is a master information block (MIB).

23. An apparatus for wireless communications, comprising:
means for receiving a system information block (SIB) with an indication of a coordinated multipoint (CoMP) identification linked to one or more channel state information reference signal (CSI-RS) ports from a plurality of nodes; and
means for monitoring signals transmitted on the CSI-RS ports linked to the CoMP identification.

24. The apparatus of claim 23, wherein the monitoring is performed after entering an idle mode.

25. The apparatus of claim 23, wherein the plurality of nodes comprise remote radio heads (RRHs) with different cell identifications.

26. The apparatus of claim 23, further comprising:
means for determining a CoMP reference signal received power (RSRP) based on the monitored signals.

27. The apparatus of claim 26, further comprising:
means for computing a CoMP reference signal received quality (RSRQ) as a ratio of the CoMP RSRP to a received signal strength indicator (RSSI).

28. The apparatus of claim 23, further comprising:
means for receiving, from each of the plurality of nodes, a broadcast paging transmission as part of a CoMP transmission; and
means for accessing at least one serving cell after receiving the broadcast paging transmission.

29. The apparatus of claim 28, wherein the means for accessing comprises:
means for searching for the at least one serving cell; and
means for transmitting a random access channel (RACH) on a configured channel of the at least one serving cell.

30. The apparatus of claim 29, wherein the RACH is based on a configuration of the at least one serving cell.

31. The apparatus of claim 28, wherein the means for accessing comprises means for transmitting a random access channel (RACH) based on a configuration of the plurality of nodes.

32. The apparatus of claim 23, wherein the SIB is received through a CoMP transmission or a unicast transmission.

33. The apparatus of claim 23, wherein the SIB is a master information block (MIB).

34. A computer-program product for wireless communications, comprising a computer-readable medium having instructions stored thereon, the instructions being executable by one or more processors and the instructions comprising:
instructions for receiving a system information block (SIB) with an indication of a coordinated multipoint (CoMP) identification linked to one or more channel state information reference signal (CSI-RS) ports from a plurality of nodes; and
instructions for monitoring signals transmitted on the CSI-RS ports linked to the CoMP identification.

35. The computer-program product of claim 34, wherein the monitoring is performed after entering an idle mode.

36. The computer-program product of claim 34, wherein the plurality of nodes comprise remote radio heads (RRHs) with different cell identifications.

37. The computer-program product of claim 34, further comprising:
instructions for determining a CoMP reference signal received power (RSRP) based on the monitored signals.

38. The computer-program product of claim 37, further comprising:
instructions for computing a CoMP reference signal received quality (RSRQ) as a ratio of the CoMP RSRP to a received signal strength indicator (RSSI).

39. The computer-program product of claim 34, further comprising:
instructions for receiving, from each of the plurality of nodes, a broadcast paging transmission as part of a CoMP transmission; and
instructions for accessing at least one serving cell after receiving the broadcast paging transmission.

40. The computer-program product of claim 39, wherein the instructions for accessing comprise:
instructions for searching for the at least one serving cell; and
instructions for transmitting a random access channel (RACH) on a configured channel of the at least one serving cell.

41. The computer-program product of claim 40, wherein the RACH is based on a configuration of the at least one serving cell.

42. The computer-program product of claim 39, wherein the instructions for accessing comprises instructions for transmitting a random access channel (RACH) based on a configuration of the plurality of nodes.

43. The computer-program product of claim 34, wherein the SIB is received through a CoMP transmission or a unicast transmission.

44. The computer-program product of claim 34, wherein the SIB is a master information block (MIB).

45. A method for wireless communications, comprising:
receiving a system information block (SIB) with an indication of a coordinated multipoint (CoMP) identification linked to a plurality of nodes;
detecting one or more nodes of the plurality of nodes linked to the CoMP identification;
measuring a reference signal received power (RSRP) of each of the one or more nodes; and
determining a CoMP RSRP based on the measured RSRP of each of the one or more nodes.

46. The method of claim 45, further comprising:
computing a CoMP reference signal received quality (RSRQ) as a ratio of the CoMP RSRP to a received signal strength indicator (RSSI).

47. The method of claim 45, wherein the SIB is a master information block (MIB).

48. An apparatus for wireless communications, comprising:
logic for receiving a system information block (SIB) with an indication of a coordinated multipoint (CoMP) identification linked to a plurality of nodes;
logic for detecting one or more nodes of the plurality of nodes linked to the CoMP identification;
logic for measuring a reference signal received power (RSRP) of each of the one or more nodes; and
logic for determining a CoMP RSRP based on the measured RSRP of each of the one or more nodes.

49. The apparatus of claim 48, further comprising:
logic for computing a CoMP reference signal received quality (RSRQ) as a ratio of the CoMP RSRP to a received signal strength indicator (RSSI).

50. The apparatus of claim 48, wherein the SIB is a master information block (MIB).

51. An apparatus for wireless communications, comprising:
means for receiving a system information block (SIB) with an indication of a coordinated multipoint (CoMP) identification linked to a plurality of nodes;
means for detecting one or more nodes of the plurality of nodes linked to the CoMP identification;
means for measuring a reference signal received power (RSRP) of each of the one or more nodes; and
means for determining a CoMP RSRP based on the measured RSRP of each of the one or more nodes.

52. The apparatus of claim 51, further comprising:
means for computing a CoMP reference signal received quality (RSRQ) as a ratio of the CoMP RSRP to a received signal strength indicator (RSSI).

53. The apparatus of claim 51, wherein the SIB is a master information block (MIB).

54. A computer-program product for wireless communications, comprising a computer-readable medium having instructions stored thereon, the instructions being executable by one or more processors and the instructions comprising:
instructions for receiving a system information block (SIB) with an indication of a coordinated multipoint (CoMP) identification linked to a plurality of nodes;
instructions for detecting one or more nodes of the plurality of nodes linked to the CoMP identification;
instructions for measuring a reference signal received power (RSRP) of each of the one or more nodes; and
instructions for determining a CoMP RSRP based on the measured RSRP of each of the one or more nodes.

55. The computer-program product of claim 54, further comprising:
instructions for computing a CoMP reference signal received quality (RSRQ) as a ratio of the CoMP RSRP to a received signal strength indicator (RSSI).

56. The computer-program product of claim 54, wherein the SIB is a master information block (MIB).

57. A method for wireless communications, comprising:
transmitting, by a wireless node, a system information block (SIB) with an indication of a coordinated multipoint (CoMP) identification linked to one or more channel state information reference signal (CSI-RS) ports; and
transmitting signals on the linked CSI-RS ports.

58. The method of claim 57, further comprising:
transmitting, by the wireless node, a broadcast paging transmission as part of a CoMP transmission coordinated with other wireless nodes.

59. The method of claim 58, wherein the CoMP transmission is a single frequency network (SFN) transmission.

60. The method of claim 58, wherein the broadcast paging transmission is transmitted based on a demodulation reference signal (DM-RS).

61. The method of claim 58, wherein the wireless nodes comprise remote radio heads (RRHs) with different cell identifications.

62. The method of claim 58, further comprising:
upon transmitting the broadcast paging transmission, processing a random access channel (RACH) received on a configured channel of the wireless node.

63. An apparatus for wireless communications, comprising:
logic for transmitting, by a wireless node, a system information block (SIB) with an indication of a coordinated multipoint (CoMP) identification linked to one or more channel state information reference signal (CSI-RS) ports; and
logic for transmitting signals on the linked CSI-RS ports.

64. The apparatus of claim 63, further comprising:
logic for transmitting, by the wireless node, a broadcast paging transmission as part of a CoMP transmission coordinated with other wireless nodes.

65. The apparatus of claim 64, wherein the CoMP transmission is a single frequency network (SFN) transmission.

66. The apparatus of claim 64, wherein the broadcast paging transmission is transmitted based on a demodulation reference signal (DM-RS).

67. The apparatus of claim 64, wherein the wireless nodes comprise remote radio heads (RRHs) with different cell identifications.

68. The apparatus of claim 64, further comprising:
upon transmitting the broadcast paging transmission, logic for processing a random access channel (RACH) received on a configured channel of the wireless node.

69. An apparatus for wireless communications, comprising:
means for transmitting, by a wireless node, a system information block (SIB) with an indication of a coordinated multipoint (CoMP) identification linked to one or more channel state information reference signal (CSI-RS) ports; and
means for transmitting signals on the linked CSI-RS ports.

70. The apparatus of claim 69, further comprising:
means for transmitting, by the wireless node, a broadcast paging transmission as part of a CoMP transmission coordinated with other wireless nodes.

71. The apparatus of claim 70, wherein the CoMP transmission is a single frequency network (SFN) transmission.

72. The apparatus of claim 70, wherein the broadcast paging transmission is transmitted based on a demodulation reference signal (DM-RS).

73. The apparatus of claim 70, wherein the wireless nodes comprise remote radio heads (RRHs) with different cell identifications.

74. The apparatus of claim 70, further comprising:
upon transmitting the broadcast paging transmission, means for processing a random access channel (RACH) received on a configured channel of the wireless node.

75. A computer-program product for wireless communications, comprising a computer-readable medium having instructions stored thereon, the instructions being executable by one or more processors and the instructions comprising:
instructions for transmitting, by a wireless node, a system information block (SIB) with an indication of a coordinated multipoint (CoMP) identification linked to one or more channel state information reference signal (CSI-RS) ports; and
instructions for transmitting signals on the linked CSI-RS ports.

76. The computer-program product of claim 75, further comprising:
instructions for transmitting, by the wireless node, a broadcast paging transmission as part of a CoMP transmission coordinated with other wireless nodes.

77. The computer-program product of claim 76, wherein the CoMP transmission is a single frequency network (SFN) transmission.

78. The computer-program product of claim 76, wherein the broadcast paging transmission is transmitted based on a demodulation reference signal (DM-RS).

79. The computer-program product of claim 76, wherein the wireless nodes comprise remote radio heads (RRHs) with different cell identifications.

80. The computer-program product of claim 76, further comprising:
upon transmitting the broadcast paging transmission, instructions for processing a random access channel (RACH) received on a configured channel of the wireless node.
